(19) United States
(12) Patent Application Publication
(10) Pub. No.: US 2019/0014799 A1
(43) Pub. Date: Jan. 17, 2019

(54) CONTAINER TREATMENT SYSTEM AND METHOD FOR SWITCHING THE OPERATION OF A CONTAINER TREATMENT SYSTEM

(71) Applicant: KRONES AG, Neutraubling (DE)

(72) Inventors: Wolfgang HAHN, Neutraubling (DE); Robert KLEIN, Neutraubling (DE)

(73) Assignee: Krones AG, Neutraubling (DE)

(21) Appl. No.: 16/068,614

(22) PCT Filed: Dec. 9, 2016
(86) PCT No.: PCT/EP2016/080397

§ 371 Date: Jul. 6, 2018

(30) Foreign Application Priority Data
Jan. 13, 2016 (DE) 10 2016 200 281.3

(51) Int. Cl. A23L 3/02; B65B 57/00; B65B 59/02; A23L 3/00; B65G 43/08; B65G 47/68

(52) U.S. Cl. CPC A23L 3/02; B65B 57/00; B65B 59/02; B65G 2201/0244; B65G 43/08; B65G 47/682; A23V 2002/00; A23L 3/003

(57) ABSTRACT

The invention relates to a method for switching the operation of a container treatment system (100) from a first operating mode to a second operating mode. Containers (130) are treated at least in a container treatment machine (101) comprising a heater, a pasteurizer, or a heat exchanger in the first operating mode. According to the method, the containers (130) to be treated in the first operating mode are transported into the container treatment machine (101). The containers are treated in the container treatment machine and are transported to the outlet (103) of the container treatment machine (101). Information indicating that the operation will be switched is stored in the controller of the container treatment system (100). At least one sensor (106) detects the last treated container (130) or the last container to be treated in the first operating mode and outputs a signal indicating same, and a transferring device (105) transports all the containers (130) which have been treated in the first operating mode from the outlet (103) of the container treatment machine to a transport device (104) at the outlet of the container treatment machine on the basis of the indicative signal. The invention also relates to a container treatment system for carrying out the method.

### RELATED APPLICATIONS

This patent application claims the benefit of International Application No. PCT/EP2016/080397, filed Dec. 9, 2016, that claims priority to German Application No. 102016200281.3, filed Jan. 13, 2016, wherein the entire contents of both are hereby incorporated by reference.

### FIELD OF INVENTION

The present disclosure relates to a method for switching the operation of a container treatment system, and a container treatment system.

### BACKGROUND

It has been common up to now to have a plurality of necessary manual switching, in particular the empty running of container treatment machines within a container treatment system, carried out manually by an operator when a switching of the container treatment system from a first operating mode to a second operating mode is accomplished.

This on the one hand requires the permanent presence of an operator, and it leads, on the other hand, to delays when the operation is being switched since the operator optionally has to change between several container treatment machines of the container treatment system to cause the required switching.

### BRIEF DESCRIPTION OF THE DRAWINGS

FIG. 1 schematically shows a plan view onto a container treatment system according to one embodiment.

FIG. 2 shows an embodiment of a transferring device as a transferring beam in an outlet of a container treatment machine.

FIGS. 3a-c show embodiments in which containers are treated according to two operating modes with a container treatment machine, and corresponding temperature profiles.

FIG. 4 shows an embodiment in which containers are treated without a container treatment machine according to one operating mode.

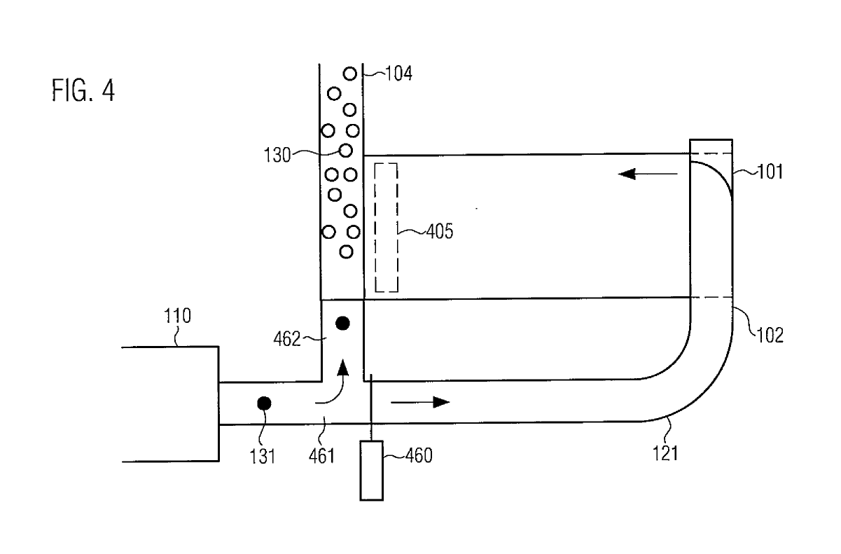

### DETAILED DESCRIPTION

An object to be achieved consists in providing a method for switching the operation of a container treatment system which can be effected preferably without any intervention by an operator and possibly also more quickly.

This object is achieved by methods for switching the operation of a container treatment system and a container treatment system for treating containers according to various embodiments of the present disclosure.

According to embodiments of the disclosure, in a method for switching the operation of a container treatment system from a first operating mode to a second operating mode, the containers are treated at least in one container treatment machine comprising a heater and/or a pasteurizer and/or a heat exchanger in the first operating mode, the method further comprising that the containers to be treated in the first operating mode are transported into the container treatment machine, wherein the containers are treated in the container treatment machine and are transported to the outlet of the container treatment machine, wherein information indicating that the operation will be switched is stored in the controller of the container treatment system, wherein at least one sensor detects the last treated containers or the last containers to be treated in the first operating mode and outputs a signal indicating the same, and a transferring device transports all the containers which have been treated in the first operating mode from the outlet of the container treatment machine to a transport device at the outlet of the container treatment machine on the basis of the indicative signal.

Here, the first operating mode and the second operating mode may relate to any switching of the container treatment system and also of individual container treatment machines. Thus, switching to another type of containers may be effected. Switching of one or several treatment parameters, for example a temperature employed in the container treatment machine for treating the containers, is possible. Even switching of the treatment of the containers in such a way that one or several container treatment machines are left out after the switching of the container treatment system for the treatment of the container, or are used for treating containers after the switching, is conceivable. Even the filling of various products in the various operating modes is conceivable. Thus, products to be heated or pasteurized in different ways in the different operating modes may be filled into otherwise similar or else different containers. In general, the switching of the operating mode may thus relate to any operation which concerns the separation of two products, two types of containers or the treatment thereof. This in particular comprises those operations where the outlet of a container treatment machine is emptied.

The outlet of the container treatment machine may comprise a support surface onto which the containers are pushed from a transport section extending in the container treatment machine. The support surface may form the transition between a transport section in the container treatment machine and the transport device. In the transport section, the containers may be transported in a disordered manner, in particular in several rows, for example 10 or more, one next to the other. The transport device and the transport section may be embodied as continuous conveyors, wherein the transport device may have a width corresponding to two or three times the diameter of a container, so that in the transport device, too, the containers may be transported in a disordered manner The transferring device may be provided as a movable transferring beam and be in particular configured to move in parallel to the direction of transport of the containers in the container treatment machine, so that containers may be pushed from the support plate following the transport section. In the process, the transport of the containers in the transport device may be effected more quickly than the transport through the container treatment machine.

For the method according to embodiments of the disclosure, the presence or interaction of an operator with the container treatment system for emptying the outlet in the container treatment machine is no longer necessary. This may save time. Furthermore, containers that are treated according to the first operating mode may be prevented from intermingling with containers that are treated according to the second operating mode since these containers are separated using the transferring device.

In one embodiment of the method, the second operating mode defines a treatment of containers in the container treatment machine other than in the first operating mode, and the container treatment machine is switched to the second operating mode after the containers treated in the first operating mode have been transported out of the container treatment machine by the transferring device and before containers to be treated in the second operating mode are transported into the container treatment machine. It is thus ensured that the containers to be treated in different operating modes do not undergo a treatment according to the respective other operating mode at least partially. The quality of the manufactured products may thus be increased.

Furthermore, the transferring device may be, after the transport of the containers onto the transport device, moved to a starting position in the region of the outlet of the container treatment machine, and/or the transferring device may transport the containers treated in the first operating mode out of the outlet before containers treated in the second operating mode are transported into the container treatment machine. It may thus be ensured that the containers treated in different ways are spatially separated and the respective containers are simultaneously exclusively treated in the operating mode intended for them.

In another embodiment, the second operating mode defines a treatment of containers without the container treatment machine. This means that while the containers to be treated in the second operating mode undergo a treatment in the container treatment system, this is done without the container treatment machine, preferably without the containers being transported into the container treatment machine at all.

In a further development of this embodiment, the transferring device remains, after the transport of the containers treated according to the first operating mode to the transport device, in a position at the outlet of the container treatment machine, and containers treated in the second operating mode move at the transferring device along the transport device. The transferring device may be advantageously utilized in this position to prevent the containers to be treated according to the second operating mode from entering the container treatment machine even if these containers are transported in the transport device in a congestive way.

A blocking device disposed at the inlet of the container treatment machine may furthermore block the inlet after the last container to be treated in the first operating mode has entered the container treatment machine and before a container treated in the second operating mode passes the blocking device. In this manner, one may prevent the containers to be treated according to the second operating mode from entering the container treatment machine. The blocking device may also be arranged in a transport device leading to the inlet and be embodied for blocking or clearing said transport device.

In a further development of this embodiment, the containers to be treated in the second operating mode are conveyed from the blocking device onto a bypass transport device, and transported from the bypass transport device to the transport device at the outlet of the container treatment machine. By this embodiment, a complete redirection of the containers around the container treatment machine is possible. Thus, containers do not unintentionally enter the container treatment machine. Simultaneously, the transport path of the containers is reduced, thus reducing the production time for the containers to be treated in the second operating mode.

According to one embodiment, the containers are treated by a further container treatment machine according to the first or second operating mode before the containers are transported into the container treatment machine. The further container treatment machine may be embodied, for example, as a filler that fills a product into the containers. Other embodiments of the further container treatment machine, for example as a printing or labeling machine, but also as a closer, are also possible.

The inventive container treatment system for treating containers in the beverage processing industry comprises a container treatment machine to be operated in at least two operating modes which may be embodied as a heater and/or a pasteurizer and/or a heat exchanger, wherein the container treatment machine includes an inlet and an outlet for containers, wherein at the outlet, a transport device is provided, and wherein a sensor for detecting containers treated or to be treated in the container treatment machine is provided, and wherein the container treatment machine includes a transferring device movable in the direction of the transport device, wherein the container treatment system is embodied for carrying out one of the above methods. A switching of the container treatment system may thus be effected much more expeditiously and with fewer interventions by an operator.

In one embodiment, the transferring device is embodied as a transferring beam. The latter may be moved, for example, over the outlet in the direction of the transport device such that the containers may be transported from the outlet onto the transport device.

Furthermore, the transferring device may be arranged to be movable between a starting position and an end position in the outlet.

The transferring device may be embodied in the end position so as to limit the transport device. One may thus omit an additional limiting rail, such as an insertion rail, if the container treatment machine is not to be charged with containers in one of the operating modes.

Furthermore, a blocking device for blocking and clearing the inlet for containers may be provided in the inlet. Thus, a bypass of the container treatment machine may be created if one operating mode of the container treatment system does not include a treatment of containers in the container treatment machine.

In a further development of this embodiment, a bypass transport device is arranged upstream of the blocking device which connects the inlet or a transport device leading to it with the transport device, wherein containers may be transported from the blocking device into the bypass transport device if the blocking device blocks the inlet for containers. If the container treatment machine is not used for treating containers in a certain operating mode, the transport path of the containers may also be shortened with this embodiment.

In one embodiment, upstream of the inlet, a further container treatment machine is arranged and embodied to treat containers according to the first and/or the second operating mode.

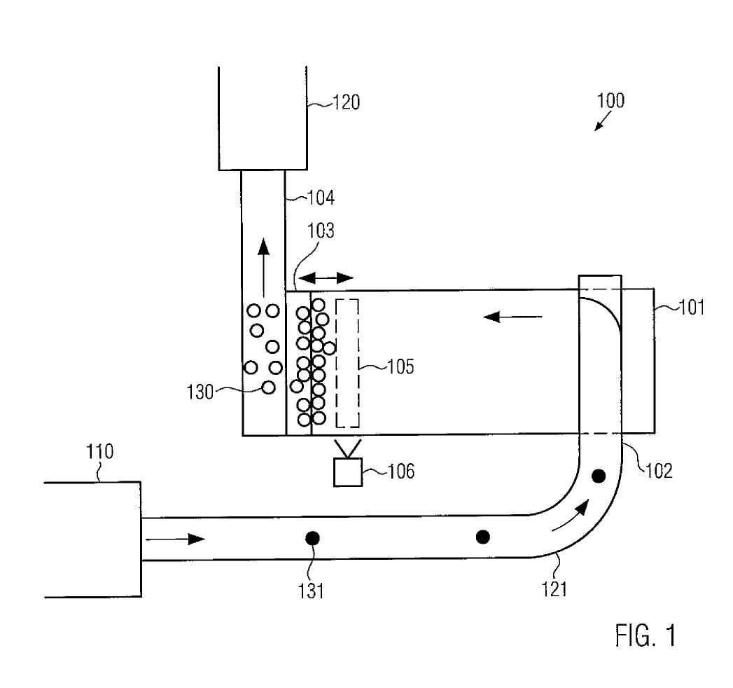

FIG. 1 shows an embodiment of a container treatment system 100 in accordance with embodiments of the disclosure. The container treatment system 100 may comprise a plurality of container treatment machines 101, 110, 120 which are interconnected by suited transport devices 121 and 104. According to embodiments of the disclosure, the container treatment system 100 comprises at least one container treatment machine 101 which is embodied as a heater, a pasteurizer or a heat exchanger and may be used to heat the containers to a certain temperature or to cool them down. This equally applies to the product filled into the containers. The further container treatment machines may be, for example, labeling machines, fillers, closers or printing machines. Other container treatment machines may also be integrated in the system 100. In particular, a closer and a filler may be arranged upstream of the container treatment machine 101, so that the containers are already filled and closed when they are transported into the container treatment machine 101.

The containers 130 are usually transported slowly and in a disordered manner within the container treatment machine 101. In particular, the containers may be transported, at least in the region of the container treatment machine, closely in groups of containers or in a continuous disordered flow of containers. The transport through the container treatment machine 101 may last between several minutes up to one hour or more (in particular in pasteurizers). The capacity of the container treatment machine 101 therefore is normally several 1,000 to 10,000 containers. Since the containers are transported as a continuous flow in the container treatment machine 101, there is a pile-up pressure of the containers at the outlet 103 of the container treatment machine 101 in the direction of transport indicated by the arrow. By this pile-up pressure, the containers in front in the direction of transport are pushed onto the transport device 104 following the outlet 103 by the containers at the rear in the direction of transport, and may be supplied from there to another container treatment machine 120.

Containers to be treated are supplied to the container treatment machine 101 via an inlet 102 and a transport device 121 connected therewith, for example a conveyor belt. Prior to this, the containers might have been treated in a further container treatment machine 110 upstream of the container treatment machine 101, such as a printing machine, a labeling machine, a filler or a closer.

In the method according to embodiments of the disclosure, a switching of the operating mode of the container treatment system from a first operating mode to a second operating mode is accomplished during the operation of the container treatment system 101. This switching may include that containers of a first type are to be treated in the first operating mode, and containers of a second type are to be treated in the second operating mode. The types of containers may differ, for example, concerning their size. As an alternative or in addition, process parameters of the treatment of the containers according to the first operating mode may differ from process parameters of the treatment according to the second operating mode. In particular, the temperature profiles corresponding to which the containers are treated in the container treatment machine 101 may be different for the first operating mode and the second operating mode. Other process parameters, for example the product filled into the containers, may also be different. Basically, the operating modes describe the total of all features characterizing the container treatment in the container treatment system and the containers.

Since an intermingling of the containers treated in the different operating modes may lead, in the region of the container treatment machine, to a non-correct further treatment of the containers (for example, the application of labels or the printing of the containers in a machine disposed downstream), the containers 130 treated according to the first operating mode are completely separated, at least spatially, from the containers 131 treated according to the second operating mode.

To this end, a sensor 106 may detect the last containers treated according to the first operating mode. The sensor 106 may be arranged, for example, in the region of the outlet 103 of the container treatment machine 101 and detect a gap between the containers treated according to the first operating mode and the containers treated according to the second operating mode. If this gap is detected (for example by a sensor designed as a light barrier), a signal indicative of this detection is output. This signal may be transmitted to a controller of the container treatment system 100 or the container treatment machine 101. In addition, information defining the switching from the first operating mode to the second operating mode may be stored in the controller of the container treatment system or the container treatment machine. Further embodiments of the sensor are conceivable. Thus, several sensors may be employed. For example, a sensor which detects the containers treated in different operating modes (for example via an RFID transponder integrated therein) may be provided at the inlet. In addition, a sensor for determining the running time of the containers in the container treatment machine based on the speed of the transport device may be provided in the container treatment machine. Based on these values, one may then determine when the last containers treated according to the first operating mode reach the outlet of the container treatment machine.

By means of the gathered/transmitted and stored information, the control unit or controller of the container treatment system may control a transferring device 105 to transport all containers that are or have been treated according to the first operating mode and are still located in the outlet 103 of the container treatment machine 101 to the transport device 104. The outlet 103 is thus emptied, and a distance between the containers treated according to the second operating mode and the containers treated according to the first operating mode is created or increased. An intermingling of the containers that have been treated according to the first operating mode with containers that have been treated according to the second operating mode may thus be avoided.

It is particularly advantageous if the transferring device is, when a gap is detected, activated if the information on a change of the operating mode is simultaneously present. If, for example, there are information for a filler disposed upstream of the container treatment machine indicating that the operating mode is changed, i. e. the production of a first product is terminated, these information may be utilized, together with the minimum transport time for the containers from the filler to the outlet of the container treatment machine 101, to detect the last containers treated in the first operating mode. If after the lapse of the minimum transport time, there is a gap in the flow of containers which is detected by a corresponding sensor, this gap may be interpreted as a change of the operating mode, and the transferring device 105 may be controlled to empty the outlet.

In addition or as an alternative to the sensor provided in the region of the outlet 103, a sensor may be furthermore arranged, for example, in the inlet region 102. Furthermore, the movement of the containers may be monitored by a speed measurement of the transport device in the container treatment machine. If it is known, for example, that the containers remain in the container treatment machine for 10 minutes from the inlet 102 into the container treatment machine 101 until they reach the outlet 103 of the container treatment machine 101, the transferring device may be used, when a gap in the inlet is detected, to transport the containers that have been treated according to the first operating mode and that still remain in the outlet 103 after 10 minutes into the transferring device 104.

While in the embodiment represented in FIG. 1, no containers 131 treated or to be treated according to the second operating mode are located in the container treatment machine 101, embodiments are also conceivable where at the moment when the containers 130 treated according to the first operating mode are transported onto the transport device 104 by the transferring device 105, containers 131 treated according to the second operating mode are already located in the container treatment machine. This is in particular true for embodiments where the operating modes do not differ with respect to the treatment parameters used in the container treatment machine 101 (for example temperature or dwelling time of the containers). It should be noted that this is usually not the case with pasteurizers, since here, the treatment of the filled containers is commonly effected in several zones with different temperatures, so that a switching of the treatment of the containers in a first zone (change of the operating mode) is also possible if containers to be treated with another operating mode are present in a second zone in the pasteurizer.

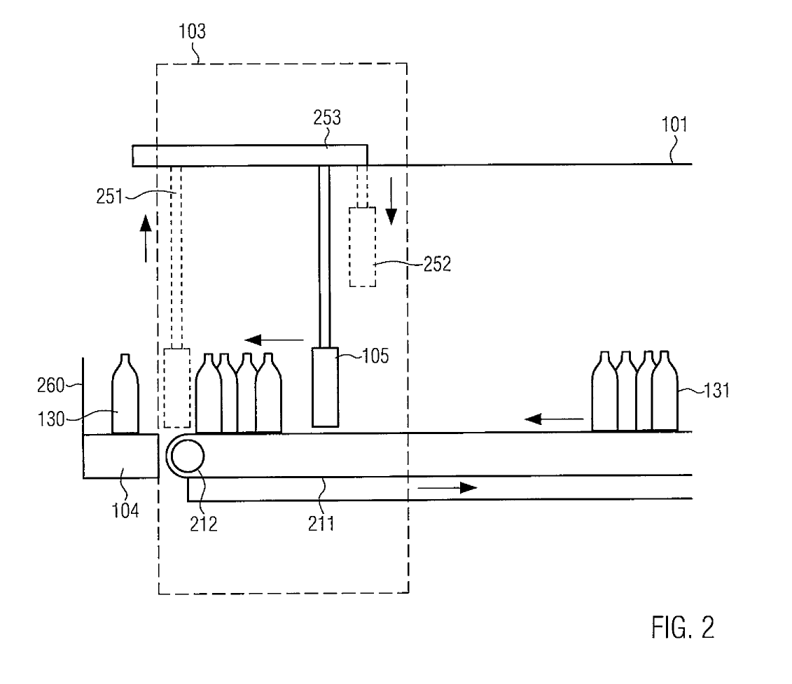

FIG. 2 shows a more detailed view of the region of the container treatment machine 101 comprising the outlet 103. In the container treatment machine 101, the containers may be transported by means of a transport device 211, such as a conveyor belt. This conveyor belt may be embodied as a continuous conveyor and pass around a deflection roller 212 at the end of the container treatment machine 101. The transport device 104 follows this deflection roller and discharges the containers in a direction, for example, perpendicular to the plane of projection. Since there usually is a small gap between these devices which may be closed or bridged by an immobile transition sheet, one container may optionally remain in the outlet region 103, if there is no pile-up pressure from following containers, without being transported onto the transport device 104. This is in particular the case if the containers have gaps with respect to each other. To this end, the transferring device 105 is employed to transport the still remaining containers 130 onto the transport device 104.

In the embodiment shown in FIG. 2, it is assumed that a corresponding gap is in particular formed if there is a switching from a first operating mode to a second operating mode. The containers 130 treated according to the first operating mode are already located in the region of the outlet 103, and the containers 131 treated according to the second operating mode are still located in the region of the container treatment machine 101, a gap without containers being present between the containers 130 and the containers 131. This gap can be detected, as was already described with reference to FIG. 1, by a corresponding sensor, for example a light barrier. Based on a signal indicative thereof, the transferring device, which is here represented as a transferring beam 105, may then be moved from a starting position 252, which is provided, for example, above the transport device 211, in the direction of transport behind the containers 130, and in the direction of transport towards the containers 130 until the transferring beam has reached the position 251 shown in a dashed line. All containers 130 located in the direction of transport in front of the transferring beam are thereby transported onto the transport device 104 by the transferring beam 105 and may thus be removed from the outlet 103. Subsequently, the transferring device or the transferring beam 105, respectively, may be returned to the starting position 252 at the beginning of the outlet 103.

The embodiment according to FIG. 2 is given by way of example. Other embodiments of the transferring device are also conceivable. In particular, the transferring device may be embodied as a pivoting beam which may be pivoted in a plane parallel to the transport plane of the containers in the direction of the transport device 104 to empty the outlet.

A drive means 253 for driving the transferring device 105 is schematically shown here. It may be controlled by the controller or control unit, for example, based on the signal of the sensor represented in FIG. 1. To prevent a possible activation of the transferring device when a gap occurs without a change of the operating mode taking place, the controller may activate the transferring beam if in addition to the detected gap, there are information indicating that a change from the first operating mode to the second operating mode is to be effected. In this case, it is sufficient for the gaps formed between the containers 130 and the containers 131 to be a few centimeters in the direction of transport, so that the transferring beam may be moved between the containers 130 on the one side and the containers 131 on the other side. Possible downtimes or buffers that could be used for retaining the containers 131 to be treated according to the second operating mode could thus be avoided if the treatment in the container treatment machine is the same for both operating modes.

It should be noted that at the transport device 104, an additional rail 260 may be provided which prevents the containers 130 from falling out, in particular while they are being transported onto the transport device 104 by the transferring device 105. This rail 260 may be arranged on the side of the transport device 104 opposite the outlet 103 of the container treatment machine 101.

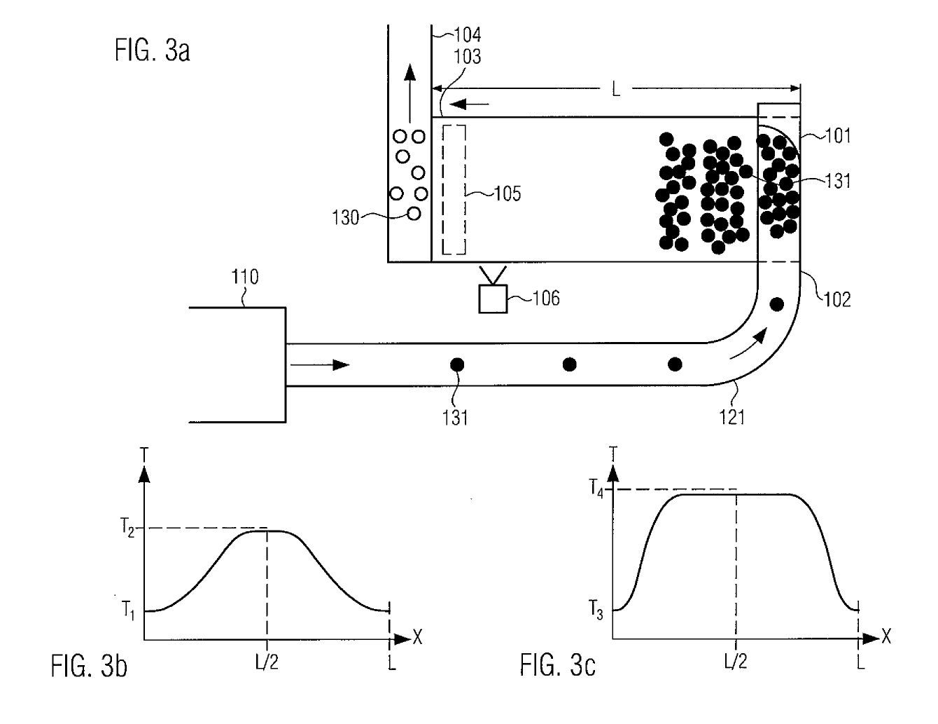

FIG. 3 shows an embodiment of the method wherein the first operating mode and the second operating mode of the container treatment system differ with respect to the temperature profile provided in the container treatment machine 101. Instead of the temperature profile, any other parameter of the operating modes relevant for the treatment of the containers in the container treatment machine 101 may differ. In such a case, the containers 130 treated according to the first operating mode are transported from the container treatment machine 101 onto the transport device 104 by the transferring device 105 before the container treatment machine is adjusted to the temperature profile according to the second operating mode, and optionally also before containers to be treated according to the second operating mode are transported into the container treatment machine 101.

So, the containers 130 treated according to the first operating mode leave at least the region of the container treatment machine 101 where they are heated or cooled to a certain temperature before the containers 131 to be treated according to the second operating mode enter a region of the container treatment machine 101 where they are heated or cooled to the temperature determined by the second operating mode. Since the region where the containers undergo different temperatures according to the first operating mode and the second operating mode does not necessarily extend over the complete length L of the container treatment machine, containers 131 (to be treated according to the second operating mode) may already be located in the region of the inlet 102 or even in the region of the container treatment machine 101 before all containers 130 (that have been treated according to the first operating mode) leave the outlet. This may be achieved, for example, by a corresponding control of the transport speed of the containers in the transport device 121 guiding the containers 131 to the inlet of the container treatment machine 101.

It should be noted that, in particular in container treatment machines 101 operating by zones (i.e., that heat or cool the containers differently in different zones and independently of other zones), the containers that have been treated according to the first operating mode do not have to be removed from the whole container treatment machine before containers to be treated in the second operating mode are transported into it. Here, it is sufficient if the containers that are treated according to the first operating mode at least are not located in a zone within the container treatment machine in which containers to be treated in the second operating mode are treated. This can be ensured by a sufficiently large gap in the flow of containers. The gap can correspond, for example, to the width of the corresponding zone in the direction of transport of the containers or be larger.

As an alternative or in addition, an interruption of the treatment of the containers during the switching from the first operating mode to the second operating mode in a container treatment machine 110 disposed upstream of the container treatment machine 101 may be provided. This may be advantageously effected during a conversion of the container treatment machine 110. During this conversion, the container treatment machine 110 might not carry out any further treatment of containers anyway. Thus, after the last container to be treated in the first operating mode has left the machine, a gap is automatically formed in the flow of containers until the container treatment machine 110 starts with the treatment of containers according to the second operating mode.

To illustrate the course of possible temperature profiles provided during the first or second operating mode in the container treatment machine, FIGS. 3b and 3c show different temperature profiles as they can be provided over the length L of the container treatment machine. These temperature profiles may be generated, for example, by a plurality of infrared sources or infrared radiators whose powers vary over the length of the container treatment machine. Furthermore, the different temperature profiles may be achieved by spraying temperature-controlled (hot or cold) water (flush-off showering) onto the containers. According to the temperature profile represented in FIG. 3b, the containers are gradually heated from a temperature T1 to a temperature T2 while they are passing through the container treatment machine. After this temperature has been reached, the containers are slowly cooled down again to their original temperature. This may be achieved, for example, by no infrared radiators being switched on in this region of the container treatment machine, or by the containers not being subjected to any temperature-controlled water.

In the embodiment represented in FIG. 3c, however, the containers are initially heated from an initial temperature T3 to a temperature T4 more quickly. This temperature is maintained over the major part of the length of the container treatment machine 101. Subsequently, the containers are cooled down again to the temperature T3 just before they leave the container treatment machine 101. A quicker cool down may be effected, for example, by applying cold air to this region of the container treatment machine.

Other embodiments of the temperature profiles, where the containers are, for example, not heated but cooled down, are also conceivable. It is moreover not necessary for the containers to be brought to their starting temperature again after they have left the container treatment machine 101 or during their transport through the container treatment machine 101.

In an alternative embodiment, it may be provided that the operating modes differ such that according to the first operating mode, the containers 130 are treated in the container treatment machine 101 (for example heated or cooled), whereas the containers 131 to be treated according to the second operating mode are not treated in the container treatment machine 101.

In such a case, on the one hand, the container treatment machine 101 may be switched off to save energy after the containers 130 have left it. Due to the time necessary for a corresponding temperature compensation, however, containers that are to be treated according to the second operating mode would undergo heating or cooling down in the container treatment machine 101 even if it was switched off.

To prevent this and simultaneously advantageously shorten the duration of transport of the containers to be treated according to the second operating mode, after the switching of the container treatment system from the first operating mode to the second operating mode, the inlet 102 or the transport section 121 in which containers may be transported from the first container treatment machine 110 to the inlet 102 of the container treatment machine 101 is blocked by a blocking device 460, so that no container is getting into the container treatment machine or a section of the transport section 121 leading to the inlet 102.

Additionally, the transport section 461 which discharges containers from the container treatment machine 110 may be followed by a bypass transport device 462. This bypass transport device may be arranged such that containers from the transport section 461 are transported onto the transport section 104.

The redirection of the containers actually transported in the transport section 461 in the direction of the inlet 102 may be effected by the blocking device 460. To this end, the blocking device may not, as shown here, be embodied as a pusher provided perpendicularly to the direction of transport, but it may extend, for example, obliquely to the direction of transport, so that containers from the transport section 461 are already redirected to the transport section or the bypass transport device 462.

In addition, in this embodiment, the transferring device 405 may be used as a boundary of the transport device 104 after it has transported containers 130 treated according to the first operating mode from the container treatment machine 101 onto the transport device 104. Since the outlet of the container treatment machine 101 would be open without the transferring device, containers 131 that are transported from the bypass transport device onto the transport device 104 could penetrate into the outlet of the container treatment machine 104 and remain standing there or tip over. To limit the transport device 104, it is therefore provided in this embodiment that the transferring device 405 remains, after the transport of the containers 130 onto the transport device 104, in the end position in which it flushes, for example, with the transport device 104 and at least closes the outlet of the container treatment machine 101, and blocks the outlet of the container treatment machine 101 during the treatment of the containers 131 according to the second operating mode. In addition, the transferring device may in this embodiment comprise an elevated rail, so that the transferring device has a height that is higher than the height of the containers. Even in case of a considerable pile-up pressure of the containers transported in the transport device 104, it may thus be prevented that containers, for example, tip over the transferring device and get into the container treatment machine 101.

1-15. (canceled)

16. A method for switching an operation of a container treatment system from a first operating mode to a second operating mode, the method comprising:
while a container treatment machine is in the first operating mode:
transporting a first plurality of containers into the container treatment machine, wherein the container treatment machine comprises at least one of a heater, a pasteurizer, or a heat exchanger;
treating the first plurality of containers in the container treatment machine;
transporting the first plurality of containers to an outlet of the container treatment machine;
detecting, by a sensor, one or more last containers of the plurality of containers that are treated or to be treated in the first operating mode;
in response to the detecting, outputting a signal indicating detection of the one or more last containers; and
transporting, by a transferring device, the first plurality of containers that have been treated by the container treatment machine in the first operating mode from the outlet of the container treatment machine to a transport device at the outlet of the container treatment machine based on the signal, wherein information indicating that the operation of the container treatment system will be switched is stored in a controller of the container treatment system.

17. The method of claim 16, further comprising:
switching the container treatment machine from the first operating mode to the second operating mode, wherein the second operating mode defines a treatment of a second plurality of containers by the container treatment machine that is different than the first operating mode, wherein the switching occurs after the first plurality containers have been transported out of the container treatment machine by the transferring device and before the second plurality of containers are transported into the container treatment machine.

18. The method of claim 16, further comprising:
after the transporting of the first plurality of containers onto the transport device, moving the transferring device into a starting position in proximity to the outlet of the container treatment machine.

19. The method of claim 16, wherein the transport device transports the first plurality of containers treated in the first operating mode out of the outlet before a second plurality of containers are transported into the containment treatment machine for treatment in the second operating mode.

20. The method of claim 16, wherein the second operating mode defines a treatment of a second plurality of containers without the container treatment machine.

21. The method of claim 20, further comprising:
maintaining the transferring device in a position at the outlet of the container treatment machine after the transport of the first plurality of containers to the transport device, wherein a second plurality of containers treated in the second operating mode move at the transferring device along the transport device.

22. The method of claim 20, wherein a blocking device disposed in an inlet of the container treatment machine blocks the inlet after the one or more last containers in the first plurality of containers to be treated in the first operating mode has been transported into the container treatment machine and before any of the second plurality of containers to be treated in the second operating mode passes the blocking device.

23. The method of claim 22, further comprising:
conveying the second plurality of containers that are to be treated in the second operating mode from the blocking device onto a bypass transport device; and
transporting the second plurality of containers from the bypass transport device to the transport device at the outlet of the container treatment machine.

24. The method of claim 16, further comprising:
treating the first plurality of containers or a second plurality of containers by an additional container treatment machine according to the first operating mode or the second operating mode before the first plurality of containers or the second plurality of containers are transported into the container treatment machine.

25. A container treatment system comprising:
a container treatment machine configured to treat containers according to a first operating mode and a second operating mode, the container treatment machine comprising a transferring device, an inlet, an outlet and one or more of a heater, a pasteurizer or a heat exchanger;
a transport device to discharge the containers at the outlet, wherein the transferring device is movable in a direction of the transport device;
a sensor to detect the containers treated or to be treated by the container treatment machine; and
a controller that stores information indicating that the operation of the container treatment system will be switched between the first operating mode and the second operating mode;
wherein while the container treatment machine is in the first operating mode,
a first plurality of containers is to be transported into the container treatment machine,
the container treatment machine is to treat the first plurality of containers,
the first plurality of containers are to be transported to the outlet of the container treatment machine,
the sensor is to detect one or more last containers of the plurality of containers that are treated or to be treated in the first operating mode and output a signal indicating detection of the one or more last containers, and
the transferring device is to transport the first plurality of containers that have been treated by the container treatment machine in the first operating mode from the outlet of the container treatment machine to the transport device at the outlet of the container treatment machine based on the signal.

26. The container treatment system of claim 25, wherein the transferring device is a transferring beam.

27. The container treatment system of claim 25, wherein the transferring device is arranged to be movable between a starting position and an end position in the outlet.

28. The container treatment system of claim 27, wherein the transferring device limits the transport device when the transferring device is in the end position.

29. The container treatment system of claim 25, further comprising:
a blocking device for blocking and clearing the inlet for the containers, wherein the blocking device is in the inlet or in the transport device.

30. The container treatment system of claim 29, further comprising:
a bypass transport device that connects a transport section for the containers with the transport device, wherein the bypass transport device is upstream of the blocking device and the plurality of containers are transported from the blocking device into the bypass transport device if the blocking device blocks the inlet.

31. The container treatment system of claim 25, further comprising:
an additional container treatment machine to treat the plurality of containers according to at least one of the first operating mode or the second operating mode, wherein the additional container treatment machine is located upstream from the inlet of the container treatment machine.

32. The container treatment system of claim 25, wherein the controller is to switch the container treatment system from the first operating mode to the second operating mode, wherein the second operating mode defines a treatment of a second plurality of containers by the container treatment machine that is different than the first operating mode, wherein the switching occurs after the first plurality containers have been transported out of the container treatment machine by the transferring device and before the second plurality of containers are transported into the container treatment machine.

33. The container treatment system of claim 25, wherein the after the transporting the first plurality of containers onto the transport device, the transferring device is to move into a starting position in proximity to the outlet of the container treatment machine.

34. The container treatment system of claim 25, wherein the transport device is to transport the first plurality of containers treated in the first operating mode out of the outlet before a second plurality of containers are transported into the containment treatment machine for treatment in the second operating mode.

35. The container treatment system of claim 34, wherein the second operating mode defines a treatment of the second plurality of containers without the container treatment machine.
